(19) United States
(12) Patent Application Publication
(10) Pub. No.: US 2026/0055639 A1
(43) Pub. Date: Feb. 26, 2026

(54) DUAL-DRIVE INTERNAL LOCK STRUCTURE

(71) Applicant: Shenzhen Qirui Industrial Co., LTD, Shenzhen (CN)

(72) Inventor: Shengbo Wang, Shenzhen (CN)

(21) Appl. No.: 18/811,198

(22) Filed: Aug. 21, 2024

(51) Int. Cl. E05B 47/00; E05B 17/22

(52) U.S. Cl. CPC E05B 47/0012; E05B 17/22

(57) ABSTRACT

A dual-drive internal lock structure includes a fixation shell, a manual portion, and a motorized portion, where an accommodating cavity is arranged inside the fixation shell; the manual portion includes a knob and a rotating shaft, the rotating shaft is rotatably installed in the accommodating cavity and has two ends extending to the outside and connected with the knob and the linkage rod; and the motorized portion includes a control board, a motor, a main pinion arranged on the motor, and an auxiliary pinion arranged on the rotating shaft, the control board is electrically connected with the motor, the main pinion meshes with the auxiliary pinion, and the linkage rod can be driven by both the motor and the knob to implement locking and unlocking.

### TECHNICAL FIELD

The present invention pertains to the technical field of smart locks, and in particular, relates to a dual-drive internal lock structure.

### TECHNICAL BACKGROUND

A smart lock is a composite lock, mainly consisting of an outer lock, a main lock body, and an inner lock. The outer lock is provided with a lock cylinder and a recognition module, the inner lock is provided with a motor, and the main lock body is provided with a linkage rod connecting the lock cylinder and the motor. When outside a room, a user can rotate the lock cylinder by inserting a key, or control the motor by entering password information into the recognition module, to drive the linkage rod to rotate, so that the main lock body is locked or unlocked. When inside the room, the user can directly drive the linkage rod to rotate by using the motor, so that the main lock body is locked or unlocked, making the smart lock more convenient to use.

However, during actual use, it is discovered that because the inner lock has no mechanical unlocking function, if the motor is powered off, the main lock body cannot be further driven by controlling the motor, and as a result, when inside the room, the user cannot lock or open the door normally, which causes great trouble to the user, resulting in poor user experience.

### SUMMARY

### I. Resolved Technical Problem

The present invention provides a dual-drive internal lock structure, which can be locked or unlocked in a manual or electric manner, to ensure that a door can still be locked or opened normally after a motor is powered off, thereby improving user experience.

### II. Technical Solution

To achieve the foregoing objective, the present invention provides the following technical solution:

A dual-drive internal lock structure is configured to drive a main lock body of a smart lock and includes a fixation shell, a manual portion, and a motorized portion; the fixation shell is installed on an inner surface of a door, an accommodating cavity is arranged inside the fixation shell, and a rotating hole and a through hole are respectively opened in two side walls of the accommodating cavity; the manual portion includes a knob and a rotating shaft, the rotating shaft is located in the accommodating cavity and is rotatably fitted with the rotating hole, a head end of the rotating shaft penetrates the rotating hole to the outside to fix the knob, and a tail end of the rotating shaft penetrates the through hole to the outside to connect the linkage rod of the main lock body; and the motorized portion is installed in the accommodating cavity and includes a control board, a motor, a main pinion, and an auxiliary pinion, the control board is electrically connected with the motor, the motor is drivably connected with the main pinion, and the auxiliary pinion is installed on the rotating shaft and meshably connected with the main pinion, where the linkage rod can be driven by turning on the motor and turning the knob separately to drive the main lock body to be locked or unlocked.

Preferably, the main pinion and the auxiliary pinion are both bevel pinions.

### III. Beneficial Effects

Based on the dual-drive internal lock structure provided in the present invention, the accommodating cavity is arranged in the fixation shell and is configured to jointly install the motorized portion and the manual portion, so that an overall structure is more compact and appealing. The rotating shaft, the main pinion and the auxiliary pinion are fitted, and the motorized portion and the manual portion work independently, so that the user can drive the linkage rod in manual and electric drive manners, which ensures that the door can still be locked or opened normally after the motor is powered off, thereby improving user experience and overall safety.

### BRIEF DESCRIPTION OF THE DRAWINGS

The drawings are used to facilitate further understanding of the present invention, form a part of the specification, and are used with embodiments of the present invention jointly to explain the present invention, but do not constitute a limitation on the present invention. The drawings are as follows:

FIG. 1 is a schematic diagram of a use state according to the present invention;

FIG. 2 is a schematic diagram of the structure in FIG. 1;

FIG. 3 is a schematic structural diagram of a lock cylinder and a linkage rod according to the present invention;

FIG. 4 is a first schematic structural diagram of a dual-drive internal lock structure according to the present invention;

FIG. 5 is a cross-sectional view A-A of FIG. 4;

FIG. 6 shows an enlarged view of a point A in FIG. 5;

FIG. 7 is a second schematic structural diagram of a dual-drive internal lock structure according to the present invention;

FIG. 8 is a first schematic exploded view of FIG. 5;

FIG. 9 shows an enlarged view of a point B in FIG. 8;

FIG. 10 is a second schematic exploded view of FIG. 5;

FIG. 11 is a first schematic diagram of a partial structure according to the present invention;

FIG. 12 is a second schematic diagram of a partial structure according to the present invention; and

FIG. 13 is a schematic structural diagram of a cover according to the present invention.

Reference signs in the figures: 1. main lock body; 11. linkage rod; 2. fixation shell; 20. accommodating cavity; 200. stop block; 201. rotating hole; 202. through hole; 203. bearing; 21. substrate; 22. cover; 23. battery compartment; 230. battery; 3. manual portion; 31. rotating shaft; 310. insertion hole; 32. knob; 320. toggle block; 321. first restraint block; 322. second restraint block; 4. motorized portion; 41. control board; 410. initial travel detection switch; 411. left travel detection switch; 412. right travel detection switch; 42. motor; 43. main pinion; 44. auxiliary pinion; 440. contact plate; 45. sound generator; 46. control button; 5. external lock; 51. lock cylinder; 510. bump.

### DETAILED DESCRIPTION OF EMBODIMENTS

The following clearly and completely describes the technical solutions in the embodiments of this application with reference to the drawings in the embodiments of this application. Obviously, the described embodiments are only some but not all of the embodiments of this application. All other embodiments obtained by persons of ordinary skills in the art based on the embodiments of this application without creative efforts shall fall within the protection scope of this application.

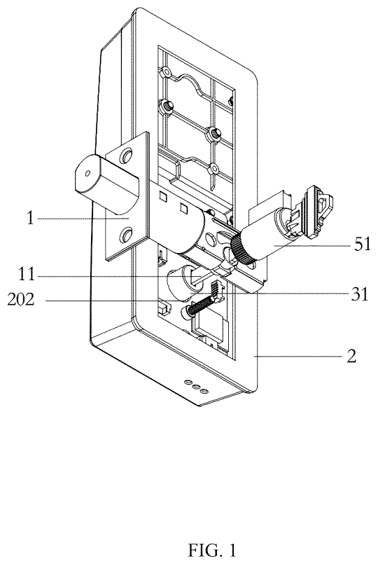

Referring to FIG. 1 to FIG. 6, a dual-drive internal lock structure is configured to drive a main lock body 1 of a smart lock and includes a fixation shell 2, a manual portion 3, and a motorized portion 4; the fixation shell 2 is installed on an inner surface of a door, an accommodating cavity 20 is arranged inside the fixation shell 2, and a rotating hole 201 and a through hole 202 are respectively opened in two side walls of the accommodating cavity 20; the manual portion 3 includes a knob 32 and a rotating shaft 31, the rotating shaft 31 is located in the accommodating cavity 20 and is rotatably fitted with the rotating hole 201, a head end of the rotating shaft 31 penetrates the rotating hole 201 to the outside to fix the knob 32, and a tail end of the rotating shaft 31 penetrates the through hole 202 to the outside to connect the linkage rod 11 of the main lock body 1; and the motorized portion 4 is installed in the accommodating cavity 20 and includes a control board 41, a motor 42, a main pinion 43, and an auxiliary pinion 44, the control board 41 is electrically connected with the motor 42, the motor 42 is drivably connected with the main pinion 43, and the auxiliary pinion 44 is installed on the rotating shaft 31 and meshably connected with the main pinion 43.

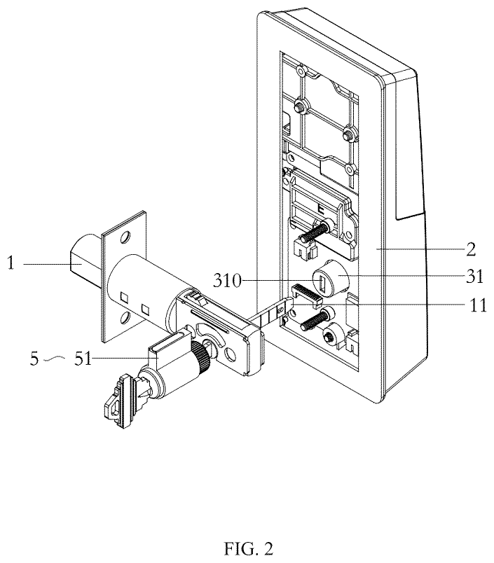

For ease of understanding, in the present invention, an external lock 5 and the main lock body 1 of the smart lock are jointly used for illustration. As shown in FIG. 1 and FIG. 2, the external lock 5 is provided with a lock cylinder 51 and a recognition module (not shown in the figures), the main lock body 1 is provided with a linkage rod 11, and the linkage rod 11 is configured to connect the lock cylinder 51 to a rotating shaft 31 of an internal lock structure. A specific operation manner is as follows:

When outside the room, a user can rotate the lock cylinder 51 by inserting a key, or control the motor 42 by entering information such as a fingerprint and a password into the recognition module (not shown in the figures), so that the lock cylinder 51 or the motor 42 drives the linkage rod 11 to drive the main lock body 1 to be locked or unlocked. Because the lock cylinder 51 and the motor 42 are independently arranged, when the motor 42 is powered off, the user can still use the key to manually open or lock the door.

When inside the room, the user turns the knob 32 or controls the motor 42 to drive the linkage rod 11, to drive the main lock body 1 to be locked or unlocked. Due to a design of the knob 32, when the motor 42 is powered off, the user can still manually open or lock the door by turning the knob 32.

Specifically, during actual use, if the motor 42 is turned on, the main pinion 43 and the auxiliary pinion 44 are driven, then the rotating shaft 31, the linkage rod 11, and the knob 32 are rotated synchronously, and the rotating linkage rod 11 drives the main lock body 1 to switch between a locked state and an unlocked state. In addition, the motor in an on-state relatively tightly locks the main pinion 43, and therefore, the main pinion 43 can also drive the auxiliary pinion 44 to rotate, and at this moment, the user cannot turn the knob 32. If the motor 42 is powered off, the motor outputs shaft idling, and at this moment, the main pinion 43 cannot restrict rotation of the auxiliary pinion 44 any longer, the user can directly turn the knob 32 to synchronously drive the rotating shaft 31 and the linkage rod 11, and the rotating linkage rod can drive the main lock body 1 to switch between the locked state and the unlocked state.

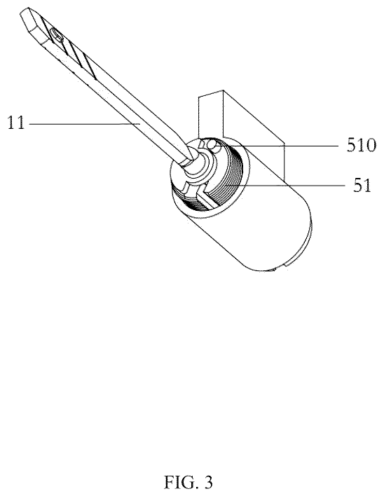

It should be noted that, as shown in FIG. 3, there is some avoidance space between the linkage rod 11 and the lock cylinder 51, the lock cylinder 51 is provided with a bump 510, the bump 510 can abut against and drive the linkage rod 11 only when the lock cylinder 51 is rotated to some extent, and therefore, when the motor 42 or the knob 32 drives the rotating shaft 31 and the linkage rod 11 to rotate synchronously, if the linkage rod 11 does not come into contact with the bump 510 after rotation, the lock cylinder 51 is not affected. The external lock 5 and the main lock body 1 both belong to existing products, installation and use of parts such as the lock cylinder 51, the recognition module, and the linkage rod 11 belong to conventional technical means, and therefore, only a related working principle is briefly described in the present invention, and a specific structure is not described in detail.

In conclusion, based on the internal lock structure in the present invention, the accommodating cavity 20 is arranged in the fixation shell 2 and is configured to jointly install the motorized portion 4 and the manual portion 3, so that an overall structure is more compact and appealing. The rotating shaft 31, the main pinion 43 and the auxiliary pinion 44 are fitted, and the motorized portion 4 and the manual portion 3 work independently, so that the user can drive the linkage rod 11 in manual and electric drive manners, which ensures that the door can still be locked or opened normally after the motor 42 is powered off, thereby improving user experience and overall safety.

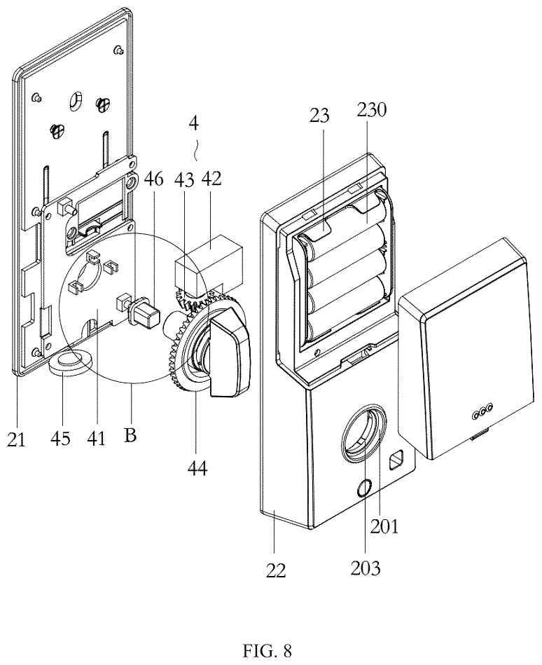

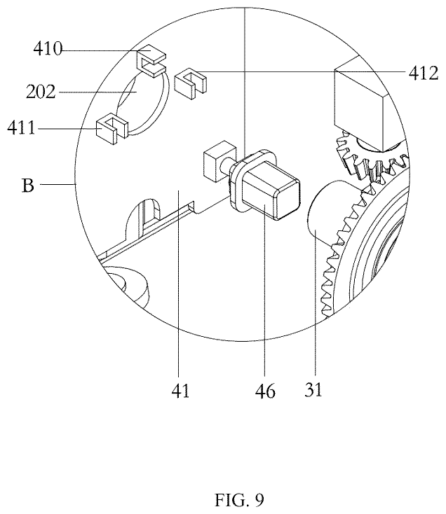

Referring to FIG. 8 to FIG. 10, the fixation shell 2 includes a substrate 21 and a cover 22, the substrate 21 can be fixedly mounted onto the inner surface of the door by using a screw, the through hole 202 is arranged in the substrate 21, the main lock body 1 is installed inside the room, and the linkage rod 11 can penetrate the door body and the through hole 202 and is connected with the knob 32. The cover 22 is detachably arranged on the substrate 21 to form the accommodating cavity 20, and the rotating hole 201 is arranged in the cover 22. The detachable design of the substrate 21 and the cover 22 facilitates not only installation of the fixation shell 2 but also assembly and maintenance of the manual portion 3 and the motorized portion 4.

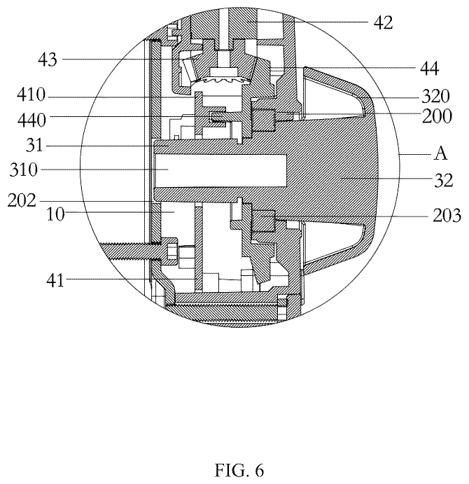

Referring to FIG. 6 to FIG. 10, the main pinion 43 and the auxiliary pinion 44 are both bevel pinions. Bevel pinion transmission can improve transmission efficiency of the main pinion 43 and the auxiliary pinion 44, effectively reduce transmission noise, can also reduce abrasion, and prolong service life.

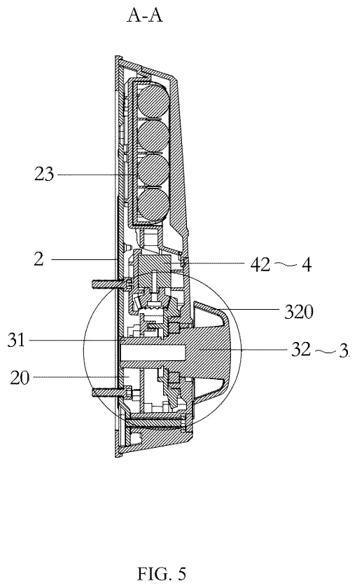

Referring to FIG. 5 to FIG. 10, a bearing 203 is installed in the rotating hole 201, and the rotating hole 201 is rotatably fitted with the rotating shaft 31 via the bearing 203. The bearing 203 can have a function of supporting the rotating shaft 31, so that the rotating shaft 31 and the fixation shell 2 are closely fitted, which improves installation stability, and can also reduce friction generated during rotation of the rotating shaft 31, prolong service life, and reduce noise caused by friction.

Referring to FIG. 2, an insertion hole 310 is arranged in the tail end of the rotating shaft 31, and the linkage rod 11 is plugged into the insertion hole 310. The design facilitates disassembly and assembly of the linkage rod 11 and the rotating shaft 31.

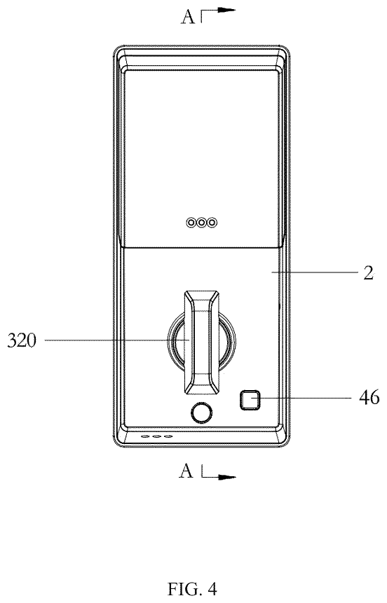

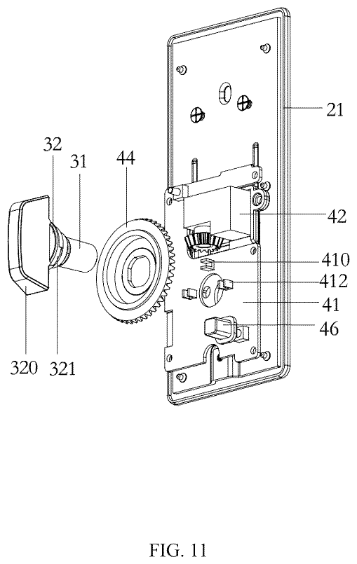

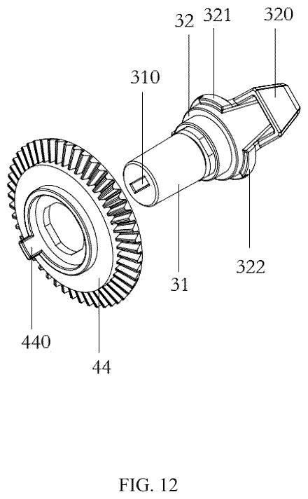

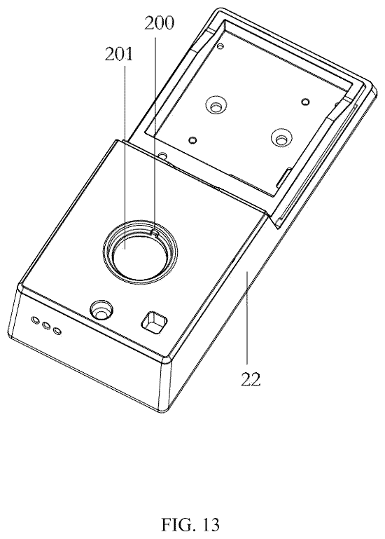

Referring to FIG. 4 to FIG. 13, different users operate the knob 32 in different manners due to their habits. For example, people habitually turn the knob 32 rightward to lock the door inside the room, and left-handers habitually turn the knob 32 leftward to lock the door inside the room. These two operation manners are exactly opposite, and as a result, a few users often forget to lock the door. To resolve the problem, in the present invention, the fixation shell 2 is provided with a stop block 200 in the rotating hole 201, and the knob 32 is provided with a first restraint block 321 and a second restraint block 322; and turning the knob 32 leftward can drive the first restraint block 321 to abut against the stop block 200, turning the knob 32 rightward can drive the second restraint block 322 to abut against the stop block 200, and when the stop block 200 abuts against the first restraint block 321 or the second restraint block 322, the main lock body 1 is in a locked state; and when the stop block 200 is located between the first restraint block 321 and the second restraint block 322, the main lock body 1 is in an unlocked state.

Specifically, when in use, the knob 32 can be turned leftward or rightward to drive the rotating shaft 31, and further drive the main lock body 1 to switch between the locked or unlocked state. Therefore, the first restraint block 321, the second restraint block 322 and the stop block 200 are fitted, so that the knob 32 has a function of two-way rotation and can be adapted to users with different use habits, thereby further improving user experience. In addition, the stop block 200 can limit a rotation range of the first restraint block 321 or the second restraint block 322, to prevent the main lock body 1 in the locked state from being unlocked again because the knob 32 is rotated excessively in the same direction.

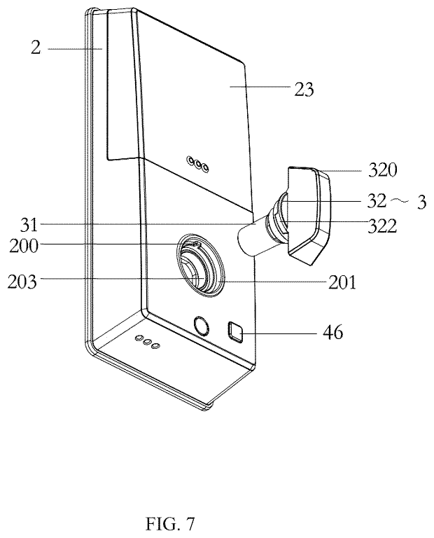

Referring to FIG. 7 to FIG. 13, the knob 32 is provided with a toggle block 320, and the toggle block 320 has a vertical position corresponding to the unlocked state of the main lock body 1 and has a horizontal position corresponding to the locked state of the main lock body 1; and the first restraint block 321 abuts against the stop block 200, or the second restraint block 322 abuts against the stop block 200, so that the toggle block 320 can be transferred from the vertical position to the horizontal position.

Specifically, usually, the main lock body 1 is in the unlocked state, and the toggle block 320 is correspondingly in the vertical position; and when the knob 32 is turned leftward to enable the first restraint block 321 to abut against the stop block 200, or the knob 32 is turned rightward to enable the second restraint block 322 to abut against the stop block 200, the main lock body 1 is in the locked state, and the toggle block 320 is correspondingly in the horizontal position. Therefore, based on the current position of the toggle block 320, the user can directly determine whether the door is locked, thereby reducing possibility that the user forgets to lock the door.

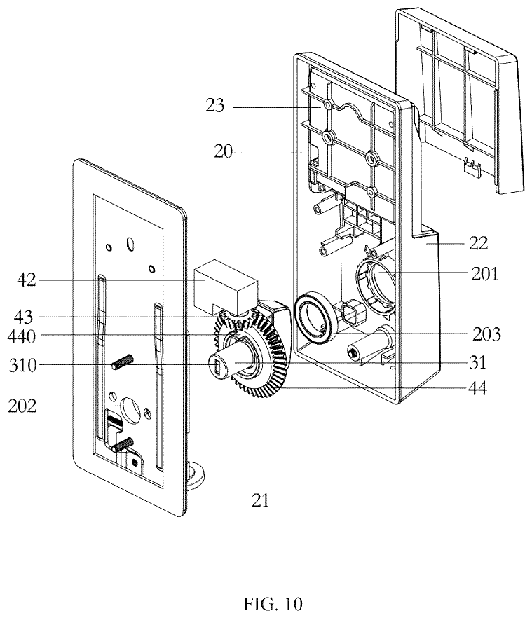

Referring to FIG. 10, the insertion hole 310 is minus-shaped and is parallel to the toggle block 320, and the linkage rod 11 is also minus-shaped and fits the insertion hole 310. With this design, the knob 32 can be plugged into the linkage rod 11 in only one direction during installation, which can effectively avoid mutual switching between the horizontal position and the vertical position of the toggle block 320 due to an installation error of the knob 32, thereby avoiding causing trouble to the user.

Referring to FIG. 6 to FIG. 13, an initial travel detection switch 410, a left travel detection switch 411, and a right travel detection switch 412 are installed on the control board 41, and a contact plate 440 is installed on the auxiliary pinion 44; when the stop block 200 is located between the first restraint block 321 and the second restraint block 322, the contact plate 440 is aligned with the initial travel detection switch 410; when the first restraint block 321 abuts against the stop block 200, the contact plate 440 is aligned with the left travel detection switch 411; and when the second restraint block 322 abuts against the stop block 200, the contact plate 440 is aligned with the right travel detection switch 412.

Specifically, when the contact plate 440 is aligned with the initial travel detection switch 410, the stop block 200 is located between the first restraint block 321 and the second restraint block 322, so that the main lock body 1 is in the unlocked state.

When the motor 42 drives the knob 32 to turn leftward to enable the contact plate 440 to be aligned with the left travel detection switch 411, or the motor 42 drives the knob 32 to turn rightward to enable the contact plate 440 to be aligned with the right travel detection switch 412, the main lock body 1 is in the locked state. The left travel detection switch 411 or the right travel detection switch 412 can send a shutdown instruction to the motor 42 through the control board 41, to prevent the first restraint block 321 or the second restraint block 322 from impacting the stop block 200 because the motor 42 continues driving the knob 32 to rotate, thereby effectively avoiding damage to the motor 42 and the knob 32.

Referring to FIG. 7 and FIG. 8, the motorized portion 4 further includes a sound generator 45, and the sound generator 45 is installed in the accommodating cavity 20 and electrically connected with the control board 41; and when the contact plate 440 is aligned with the initial travel detection switch 410, the left travel detection switch 411, and the right travel detection switch 412, the control board 41 sends an instruction to drive the sound generator 45 to generate a sound.

Specifically, after the user rotates the knob 32 via the motor 42 or manual control, based on a sound prompt, the user can determine whether the knob 32 is sufficiently rotated, to ensure that the main lock body 1 can be locked or unlocked normally, thereby further reducing possibility that the user forgets to lock the door and ensuring safety during use. Two types of sounds can be preset for the sound generator 45 to correspond to the locked state and unlocked state of main lock body 1 respectively, which further facilitates recognition and determination of the user.

Referring to FIG. 7 and FIG. 8, the motorized portion 4 further includes a control button 46, the control button 46 is installed on the fixation shell 2 and is electrically connected with the control board 41, and when inside the room, the user can directly control start and stop of the motor 42 by manually pressing the control button 46, to drive the rotating shaft 31 to drive the main lock body 1 to be locked or unlocked. The solution of driving the motor 42 to start and stop by using the control button 46 to send a signal to the control board 41 belongs to the prior art, and therefore, its circuit structure is not described in detail in the present invention.

Referring to FIG. 5 to FIG. 10, a battery compartment 23 for installing a battery 230 is also arranged inside the fixation shell 2, and the battery compartment 23 is electrically connected with the control board 41, to supply power to electronic elements such as the motor 42 and the sound generator 45.

It should also be noted that, although the embodiments of this application are shown and described, persons of ordinary skills in the art can understand that various changes, modifications, replacements, and variants can be made to these embodiments without departing from the principle and spirit of this application.

What is claimed is:

1. A dual-drive internal lock structure, configured to drive a main lock body of a smart lock and comprising:
a fixation shell, wherein the fixation shell is installed on an inner surface of a door, an accommodating cavity is arranged inside the fixation shell, and a rotating hole and a through hole are respectively opened in two side walls of the accommodating cavity;
a manual portion, wherein the manual portion comprises a knob and a rotating shaft, the rotating shaft is located in the accommodating cavity and is rotatably fitted with the rotating hole, a head end of the rotating shaft penetrates the rotating hole to the outside to fix the knob, and a tail end of the rotating shaft penetrates the through hole to the outside to connect the linkage rod of the main lock body; and
a motorized portion, wherein the motorized portion is installed in the accommodating cavity and comprises a control board, a motor, a main pinion, and an auxiliary pinion, the control board is electrically connected with the motor, the motor is drivably connected with the main pinion, and the auxiliary pinion is installed on the rotating shaft and meshably connected with the main pinion, wherein
when the motor is turned on, the linkage rod can be driven to drive the main lock body to be locked or unlocked, and when the motor is turned off, turning the knob can drive the linkage rod to drive the main lock body to be locked or unlocked.

2. The dual-drive internal lock structure according to claim 1, wherein the main pinion and the auxiliary pinion are both bevel pinions.

3. The dual-drive internal lock structure according to claim 1, wherein a bearing is installed in the rotating hole, and the rotating hole is rotatably fitted with the rotating shaft via the bearing.

4. The dual-drive internal lock structure according to claim 1, wherein an insertion hole is arranged in the tail end of the rotating shaft, and the linkage rod is plugged into the insertion hole.

5. The dual-drive internal lock structure according to claim 1, wherein the fixation shell is provided with a stop block in the rotating hole, and the knob is provided with a first restraint block and a second restraint block; and turning the knob leftward can drive the first restraint block to abut against the stop block, turning the knob rightward can drive the second restraint block to abut against the stop block, and when the stop block abuts against the first restraint block or the second restraint block, the main lock body is in a locked state.

6. The dual-drive internal lock structure according to claim 5, wherein the knob is provided with a toggle block, and the toggle block has a vertical position corresponding to the unlocked state of the main lock body and has a horizontal position corresponding to the locked state of the main lock body; and the first restraint block abuts against the stop block, or the second restraint block abuts against the stop block, so that the toggle block can be transferred from the vertical position to the horizontal position.

7. The dual-drive internal lock structure according to claim 5, wherein an initial travel detection switch, a left travel detection switch, and a right travel detection switch are installed on the control board, and a contact plate is installed on the auxiliary pinion; when the stop block is located between the first restraint block and the second restraint block, the contact plate is aligned with the initial travel detection switch; when the first restraint block abuts against the stop block, the contact plate is aligned with the left travel detection switch; and when the second restraint block abuts against the stop block, the contact plate is aligned with the right travel detection switch.

8. The dual-drive internal lock structure according to claim 7, wherein the motorized portion further comprises a sound generator, and the sound generator is installed in the accommodating cavity and electrically connected with the control board; and when the contact plate is aligned with the initial travel detection switch, the left travel detection switch, and the right travel detection switch, the control board sends an instruction to drive the sound generator to generate a sound for prompt.

9. The dual-drive internal lock structure according to claim 1, wherein the motorized portion further comprises a control button, the control button is installed on the fixation shell and is electrically connected with the control board, and manually pressing the control button can directly control start and stop of the motor.

10. The dual-drive internal lock structure according to claim 1, wherein a battery compartment for installing a battery is also arranged inside the fixation shell, and the battery compartment is electrically connected with the control board.
